(19) United States
(12) Patent Application Publication
(10) Pub. No.: US 2026/0023527 A1
(43) Pub. Date: Jan. 22, 2026

(54) SYSTEMS AND METHODS FOR LARGE MODULAR MULTIPLICATION USING STREAMING INTERFACES

(71) Applicant: JPMORGAN CHASE BANK, N.A., New York, NY (US)

(72) Inventors: Kevin LOH, Singapore (SG); Yao MA, Guangdong (CN); Kaushik CHAKRABORTY, Singapore (SG); Charles LIM, Singapore (SG); Marco PISTOIA, Amawalk, NY (US)

(21) Appl. No.: 18/775,519

(22) Filed: Jul. 17, 2024

(51) Int. Cl. G06F 7/523; G06F 7/50

(52) U.S. Cl. CPC G06F 7/523; G06F 7/50

(57) ABSTRACT

A method may include: receiving, from a streaming interface, a plurality of words for a first factor in a modular multiplication problem; as each word is received: counting, by a counting module, a number of the plurality of words received; multiplying, by a multiplier module, the word by a second; shifting left, by a left shifter module, an output of the multiplier module; accumulating, by an accumulator module, an output of the left shifter module with a partially reduced output for a prior word; receiving, by the modular reducer module, a modulus and performing partial modular reduction on an output of the accumulator module; providing, by the modular reducer module, an output of the modular reducer module to the accumulator module; and repeating until all words are received from the streaming interface; performing, by the modular reducer module, final modular reduction.

### BACKGROUND OF THE INVENTION

### 1. Field of the Invention

Embodiments relate to systems and methods for large modular multiplication using streaming interfaces.

### 2. Description of the Related Art

Modular arithmetic is a system where numbers “wrap around” when reaching the modulus. Large modular arithmetic is an important operation in many cryptographic schemes, such as RSA, Advanced Encryption Standard (AES), Lattice-based cryptography, etc. With such cryptographic schemes, the size of the multiplicands can be large, which can make the use of modular multiplication computationally expensive. This creates a bottleneck for real-time processing.

### SUMMARY OF THE INVENTION

Systems and methods for large modular multiplication using streaming interfaces are disclosed. In one embodiment, a method may include: receiving, from a streaming interface, a plurality of words for a first factor in a modular multiplication problem; as each word is received: counting, by a counting module, a number of the plurality of words received from the streaming interface; multiplying, by a multiplier module, the word by a second factor in the modular multiplication problem; shifting left, by a left shifter module, an output of the multiplier module; accumulating, by an accumulator module, an output of the left shifter module with a partially reduced output for a prior word from a modular reducer module; receiving, by the modular reducer module, a modulus and performing partial modular reduction on an output of the accumulator module; providing, by the modular reducer module, an output of the modular reducer module to the accumulator module; and repeating the multiplying, shifting left, accumulating, performing modular reduction, and providing until all words are received from the streaming interface; performing, by the modular reducer module, final modular reduction on an output of the modular reducer module for a last word of the plurality of words received, resulting in a final result; and outputting, by the modular reducer module, the final result.

In one embodiment, the first factor may have a first factor bit width, the second factor may have a second factor bit width, the streaming interface may have a streaming interface bit width, and each of the plurality of words may have a bit width equal to the streaming interface bit width.

In one embodiment, the number of the plurality of words may be equal to the first factor bit width divided by the streaming interface bit width.

In one embodiment, the second factor may be received by and stored in a memory of the multiplier module, and/or the modulus may be received by and stored in a memory of the modular reducer module.

In one embodiment, a maximum left shifter bit width and an accumulator module bit width are equal to a sum of the first factor bit width and the second factor bit width.

In one embodiment, the plurality of words are received from most significant bit to least significant bit.

In one embodiment, the output of the accumulator module may be the output of the left shifter module for the first of the plurality of words.

In one embodiment, the partial modular reduction may be performed using left-shifted versions of the modulus.

According to another embodiment, an electronic device may include: a counter module that may be configured to receive, from a streaming interface, a plurality of words for a first factor in a modular multiplication problem and to count a number of the plurality of words received from the streaming interface; a multiplier module that may be configured to multiply each of the plurality of words as it is received; a second factor in the modular multiplication problem; a left shifter module that may be configured to shifting left an output of the multiplier module; an accumulator module that may be configured to accumulate an output of the left shifter module with a partially reduced output for a prior word from a modular reducer module; and a modular reduction module that may be configured to receive a modulus, to perform partial modular reduction on an output of the accumulator module, to provide an output of the modular reducer module to the accumulator module, to perform final modular reduction on an output of the modular reducer module for a last word of the plurality of words received, resulting in a final result, and to output the final result.

In one embodiment, the first factor may have a first factor bit width, the second factor may have a second factor bit width, the streaming interface may have a streaming interface bit width, and each of the plurality of words may have a bit width equal to the streaming interface bit width.

In one embodiment, the number of the plurality of words may be the first factor bit width divided by the streaming interface bit width.

In one embodiment, the second factor may be received by and stored in a memory of the multiplier module, and/or the modulus may be received by and stored in a memory of the modular reducer module.

In one embodiment, a maximum left shifter bit width and an accumulator module bit width are equal to a sum of the first factor bit width and the second factor bit width.

In one embodiment, the plurality of words are received from most significant bit to least significant bit.

In one embodiment, the output of the accumulator module may be the output of the left shifter module for the first of the plurality of words.

In one embodiment, the partial modular reduction may be performed using left-shifted versions of the modulus.

According to another embodiment, a non-transitory computer readable storage medium may include instructions stored thereon, which when read and executed by one or more computer processors, cause the one or more computer processors to perform steps comprising: receiving, from a streaming interface, a plurality of words for a first factor in a modular multiplication problem, wherein the plurality of words are received from most significant bit to least significant bit; as each word is received: counting a number of the plurality of words received from the streaming interface; multiplying the word by a second factor in the modular multiplication problem; shifting left a result of the multiplication; accumulating a result of the shifting left with a partially reduced output for a prior word; receiving a modulus and performing partial modular reduction on a result of the accumulation; and repeating the multiplying, shifting left, accumulating, performing modular reduction, and providing for all words received from the streaming interface; and performing final modular reduction on a result of the partial modular reduction of a last word of the plurality of words received, resulting in a final result; and outputting the final result.

In one embodiment, the first factor may have a first factor bit width, the second factor may have a second factor bit width, the streaming interface may have a streaming interface bit width, and each of the plurality of words may have a bit width equal to the streaming interface bit width, and the number of the plurality of words may be the first factor bit width divided by the streaming interface bit width.

In one embodiment, a maximum left shifter bit width and an accumulator module bit width are equal to a sum of the first factor bit width and the second factor bit width.

In one embodiment, the partial modular reduction may be performed using left-shifted versions of the modulus.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for large modular multiplication using streaming interfaces according to an embodiment;

FIGS. 2A and 2B illustrate a method for large modular multiplication using streaming interfaces according to an embodiment;

FIG. 3 depicts an exemplary computing system for implementing aspects of the present disclosure.

### DETAILED DESCRIPTION OF PREFERRED EMBODIMENTS

Embodiments relate to systems and methods for large modular multiplication using streaming interfaces.

Embodiments may compute modular multiplication efficiently using integrated circuits such as field programmable gate arrays (FPGAs). Embodiments are well suited for standardized stream interface and pipelining design.

Embodiments may be used for high performance cryptographic applications, such as those in finance and banking.

An example of modular multiplication is:

$$Compute Y = ( A \times B ) mod C ,$$

where A is a first factor, B is a second factor, and C is the modulus.

For security with cryptographic schemes, each of A and B require large bit-width (BW), such as at least 350 bits. The bit width of the multiplier (i.e., the number of bits required to represent the multiplier), BW_{M}, is the sum of the bit widths of A and B, which is 700 bits.

The bit width of streaming interfaces (i.e., the number of bits that can pass concurrently), BW_{S}, are much smaller, such as 32-bit AXL, 1-bit serial, etc.

Thus, embodiments address these issues by providing in-line processing of bits as they arrive from the interface, may reduce the multiplier bit-width to BW_{B}+BW_{S}, and may reduce the reduction steps to BW_{S} for each word received.

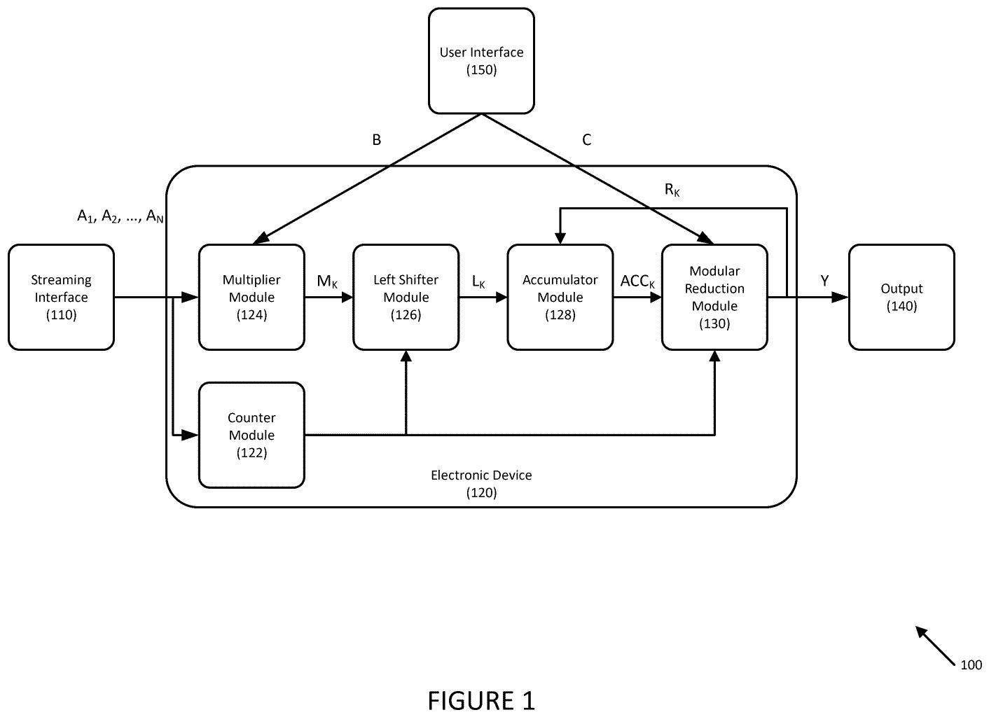

Referring to FIG. 1, a system for large modular multiplication using streaming interfaces is disclosed according to an embodiment. System 100 may include streaming interface 110, which may provide a value A, which may be divided into N words. The number of words, N, is determined by dividing the bit-width of A by the bit-width of the streaming interface, BWₛ. Thus, N times BW_{S} words are received by streaming interface 110, in order from most significant bit (the “MSB”—the highest-order place of the binary integer) to least significant bit (the “LSB”—the lowest-order place of the binary integer).

Streaming interface 110 may provide an input to electronic device 120, which may be an integrated circuit such as a FPGA. Electronic device 120 may include a plurality of modules, including counter module 122, multiplier module 124, left shifter module 126, accumulator module 128, and modular reduction module 130. Electronic device 120 may be any suitable electronic device, including FPGAs.

Counter module 112 may count the number of words of A received by streaming interface 110. Index K may count the words of A (e.g., A_{K}, where K=1 . . . . N). Once all words of A are received, counter module 112 may reset the index to 0.

Multiplier module 124 may have the value B, stored in BW_{B}, in its memory buffer. In one embodiment, the value B may be loaded via interface 150, which may be provided on a user electronic device (not shown). For example, multiplier module 124 may have a BW_{B} bit-width memory buffer, that stores the value of B. Multiplier module 124 may receive BW_{S} width-words from streaming interface 110. Each BW_{S} width-word may be directly multiplied with BW_{B} width value of B. Thus, the required fixed-point multiplication bit-width for this operation is BW_{M}=(BW_{B}+BW_{S}). This reduces the bit-width of the multiplier, BW_{M}, from BW_{A}+BW_{B} to BW_{B}+BW_{S}.

Using the example above where BW_{A} and BW_{B} are each 350 bits, if a 32-bit interface is used, BW_{M} is reduced from 700 bits to 382 bits.

Left shifter module 126 may perform a left shift with respect to the words received. The maximum bit-width of left-shifter module, BW_{L}, is equal to BW_{A}+BW_{B}.

Accumulator module 128 may accumulate the output of left shifter module, LK, with a previously partially-reduced output, R_{K-1}, from modular reducer module 130. The bit-width of accumulator module, BW_{ACC}, is equal to (BW_{A}+BW_{B}) bit.

Modular reduction module 130 may include a partial modular reducer and a final modular reducer. The partial modular reducer may perform BW_{S} steps for partial modular reduction.

The modulus, C, may be stored in BW_{C} bits in modular reducer module 130's buffer memory. In one embodiment, the modulus value may be loaded via interface 150, which may be provided on a user electronic device (not shown).

For example, after each iteration, the value of R is reduced such that it would require BW_{S} fewer bits to represent the value. On the final iteration, the bit-width is required to represent R is BW_{B} bits.

If BW_{C} is greater than or equal to BW_{B}, then the value of R on the last iteration will be less than C, and therefore R can be output as the final value Y.

If not, the value of R may still be larger than C, and a final partial modular reduction of R is required between bits BW_{B} to BW_{C}.

The final result may be provided via output 140, which may be an electronic device.

An example of combinational subtraction with left-shifted values of a modulo is described in Butler et al, “Fast Hardware Computation Of x mod z”, 2011 IEEE International Symposium on Parallel and Distributed Processing Workshops and Phd Forum, pp. 294-297 (2011), the disclosure of which is hereby incorporated, by reference, in its entirety.

In one embodiment, electronic device 110 may be a hardware device, such as an integrated circuit (e.g., a field programmable gate array. (FPGA)), etc. In another embodiment, electronic device 110 may be computer comprising a computer processor (not shown), and modules 122, 124, 126, 128, and 130 may be software modules.

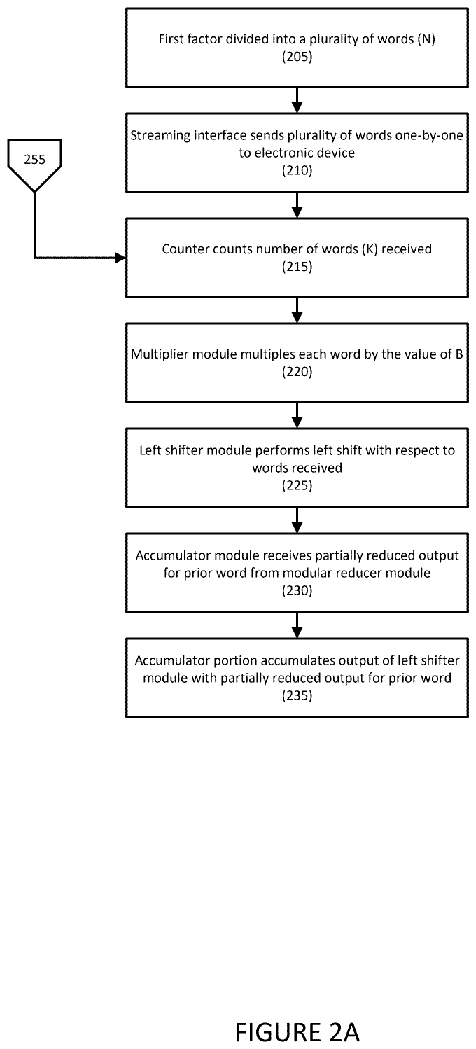

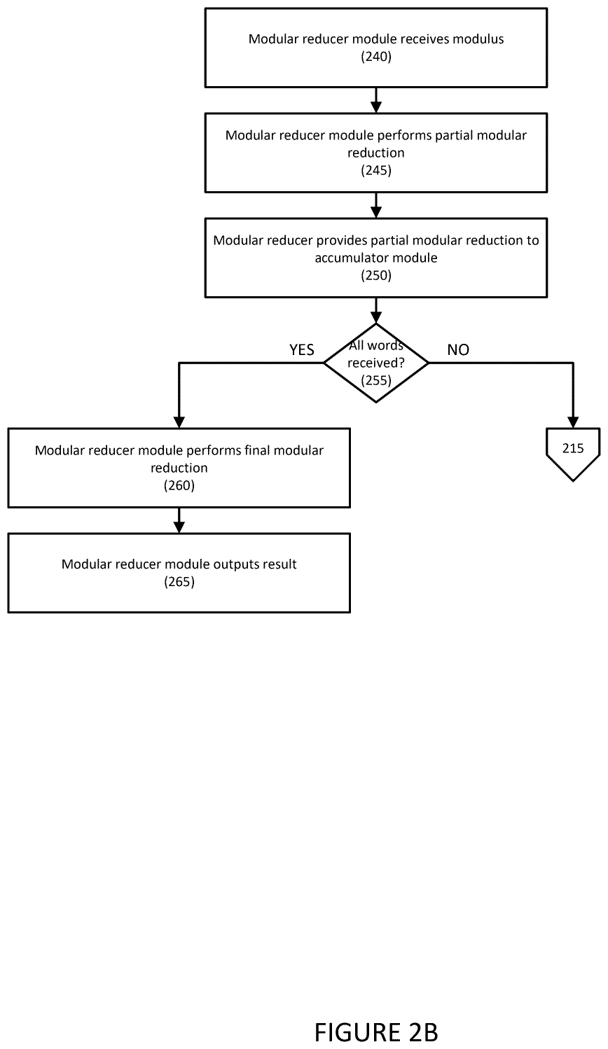

Referring to FIGS. 2A and 2B, a method for large modular multiplication using streaming interfaces is disclosed according to an embodiment.

In step 205, a first factor, A, may be divided into a plurality of words, N. The number of words, N, is determined by dividing the bit-width of A by the bit-width of the streaming interface, BWₛ. Thus, N times BW_{S} words are received by streaming interface 110, in order from most significant bit to least significant bit.

For example,

$$A = {\sum }_{K = 1}^{N} {A}_{K} \times {2}^{( {BW}_{A} - K \times {BW}_{S} )} ,$$

hence

$$A \times B = {\sum }_{K = 1}^{N} {A}_{K} \times B \times {2}^{( {BW}_{A} - K \times {BW}_{S} )} ,$$

where K is the current word.

In step 210, a streaming interface may send a plurality of words, one-by-one, to an electronic device. For example, a counter and a multiplier module may receive the words, one-by-one.

In step 215, a counter module may count the number of words received. For example, the counter may increase the value of K by 1. If the word is the first word received, the value of the counter would be 1.

In step 220, the multiplier module may have the value B, stored in BW_{B}, in its memory buffer. In one embodiment, the value B may be received from a user interface. Thus, the multiplier module may multiply each word by the value of B: M_{K}=A_{K}×B.

In step 225, a left shifter module may perform a left shift with respect to words received. The maximum bit-width of left-shifter module, BW_{L}, is equal to BW_{A}+BW_{B}. Thus,

$${L}_{K} = {A}_{K} \times B \times {2}^{( {BW}_{A} - K \times {BW}_{S} )} .$$

In step 230, an accumulator module receives a partially reduced output for a prior word from modular reducer module, and in step 235, may accumulate the output of the left shifter module with partially reduced output for prior word. The bit-width of accumulator module, BW_{ACC}, is equal to (BW_{A}+BW_{B}) bits.

In one embodiment, if the word is the first word, the output of the accumulator module is equal to the output of the left shifter module.

In step 240, the modular reducer module receives a modulus, C, from memory, and in step 245 performs BW_{S} steps for partial modular reduction. For example:

PartModRed(X, C, MSB, LSB) (X is the output of the accumulator module)

X mod C, between bits MSB to LSB of X

$$for j = MSB to LSB$$

$${C}_{LS} = C ≪ ( j - {BW}_{C} )$$

$$If X \geq {C}_{LS} , X = X - {C}_{LS}$$

return X

In step 250, the modular reducer provides partial modular reduction to the accumulator module. The current result from the modular reducer may be fed back to the accumulator module for the next iteration.

For example, the partial reduction module subtracts the input from the accumulator module with left-shifted values of the modulo. The resulting partial reduction output is such that the bits between MSB and LSB are zeros.

On each iteration, the accumulator module adds the current left shift output with the previous result from the modular reducer.

In step 255, a check may be made to see if all N words have been received and processed (i.e., does K=N). If it is not, the process may return to step 215.

If it is, in step 260, the modular reducer module may perform final modular reduction, and in step 265, may output the final result. The process may be the same process as that for partial modular reduction, except that here there are no other words being received.

An example of the algorithm performed by the process is as follows:

$$For K = 1 to N$$

$$Multiplication : {M}_{K} = {A}_{K} \times B$$

$$Left - Shift : {L}_{K} = {M}_{K} ≪ ( {BW}_{A} - ( K \times {BW}_{S} ) )$$

$$Accumulate : If K = 1 , {ACC}_{K} = {L}_{K} ; else , {ACC}_{K} = {L}_{K} + {R}_{K + 1}$$

### Partial Modular Reduce:

$${R}_{K} = PartModRed ( {ACC}_{K} , C , {BW}_{A} + {BW}_{B} - ( ( K - 1 ) \times {BW}_{S} ) , {BW}_{A} + {BW}_{B} - ( K \times {BW}_{S} ) )$$

$$Output Y : If {BW}_{C} < {BW}_{B} , Y = PartModRed ( {R}_{N} , C , {BW}_{B} , {BW}_{C} ) ;$$

$$Else , Y = {R}_{N} .$$

An example is as follows. It should be noted that this example is illustrative only and is not limiting.

For example, A has a bit-width BW_{A} of 8-bits and has a value of 254 (in binary, 11111110).

The bit-width of the streaming interface, BW_{S}, is 4-bits. Thus, the two words are A1=1111 (value is 15) and A2=1110 (value is 14).

B may also have a bit-width, BW_{B}, of 8, and may have a value of 253 (in binary, 11111101).

C may have a value of 252 (in binary, 11111100).

The expected output for (254×253) mod 252 is 2.

The multiplier may perform fixed-point multiplication between words from the streaming interface (A1 and A2) and B. Thus, the outputs of the multiplier are:

$$M 1 = A 1 \times B = 15 \times 253 = 3795 ( binary 111011010011 ) and$$

$$M 2 = A 2 \times B = 14 \times 253 = 3542 ( binary 110111010110 ) .$$

The left shifter left shifts the multiplier outputs depending on the words received. The output of the left shifted values are:

$$LS 1 = 1110110100110000 = 60720 and$$

$$LS 2 = 0000110111010110 = 3542.$$

As shown above, the zeros are padded to the right, depending on how many words were counted, i.e., no zeros padded on the last word, 4-bits padded on the second last word, etc.

The accumulator accumulates the current left shifted output with the previous modular reduction output. So:

$$ACC 1 = LS 1 == 1110110100110000 ( 60720 ) and$$

$$ACC 2 = LS 2 + ModRed 1 = 111011000110 ( 3542 + 240 = 3782 ) .$$

The module reducer performs partial modular reduction on bits in the accumulator outputs, using left-shifted versions of the modulus. The range of bits to be reduced depends on how many words were counted.

For ACC1, partial reduction is performed between bits 16 to 12:
Bit 16:1111110000000000=64512. Because this is greater than LS1, there is no reduction.
Bit 15:0111111000000000=32256. Because this is greater than or equal to LS1, this value is reduced as follows: 60720−32256=28464.
Bit 14:0011111100000000=16128. Because this is greater or equal to the reduced value of bit 15, the value is reduced as follows: 28464−16128=12336.
Bit 13:0001111110000000=8064. Because this is greater or equal to the reduced value of bit 14, the value is reduced as follows: 12336−8064=4272.
Bit 12:0000111111000000=4032. Because this is greater or equal to the reduced value of bit 13, the value is reduced as follows: 4272−4032=240

Thus, the value of ModRed1 is 0000000011110000 (240).

For ACC2, partial reduction is performed between bits 12 to 8:

$$Bit 12 : 111111000000 = 4032 , 4032 > 3782 , no reduction$$

$$Bit 11 : 011111100000 = 2016 , 2016 <= 3782 , 3782 - 2016 = 1766$$

$$Bit 10 : 001111110000 = 1008 , 1008 <= 1766 , 1766 - 1008 = 758$$

$$Bit 9 : 000111111000 = 504 , 504 <= 758 , 758 - 504 = 254$$

$$Bit 8 : 000011111100 = 252 , 252 < 255 , 254 - 252 = 2$$

Thus, the value ModRed2 is 2, which is the expected value.

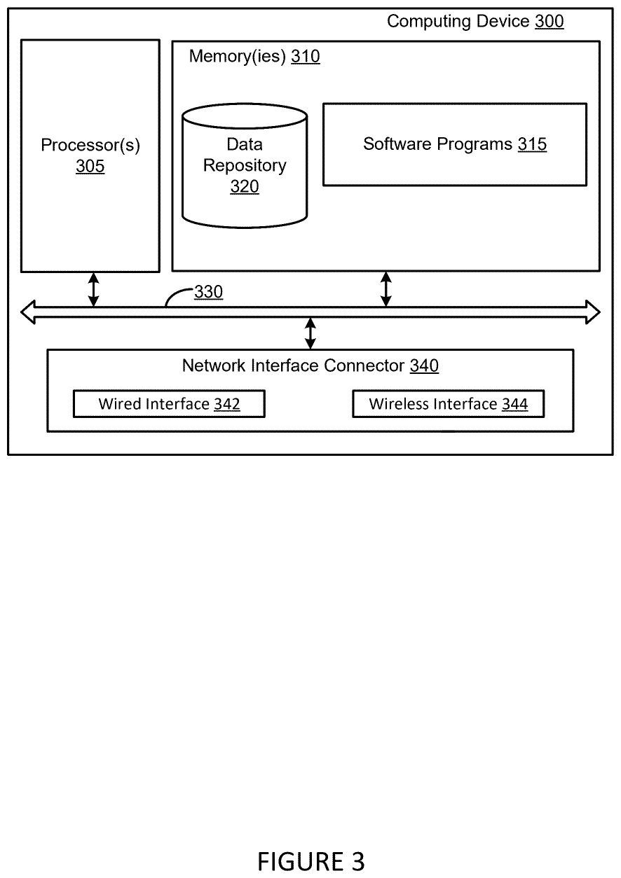

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, from a streaming interface, a plurality of words for a first factor in a modular multiplication problem;
as each word is received:
counting, by a counting module, a number of the plurality of words received from the streaming interface;
multiplying, by a multiplier module, the word by a second factor in the modular multiplication problem;
shifting left, by a left shifter module, an output of the multiplier module;
accumulating, by an accumulator module, an output of the left shifter module with a partially reduced output for a prior word from a modular reducer module;
receiving, by the modular reducer module, a modulus and performing partial modular reduction on an output of the accumulator module;
providing, by the modular reducer module, an output of the modular reducer module to the accumulator module; and
repeating the multiplying, shifting left, accumulating, performing modular reduction, and providing until all words are received from the streaming interface;
performing, by the modular reducer module, final modular reduction on an output of the modular reducer module for a last word of the plurality of words received, resulting in a final result; and
outputting, by the modular reducer module, the final result.

2. The method of claim 1, wherein the first factor has a first factor bit width, the second factor has a second factor bit width, the streaming interface has a streaming interface bit width, and each of the plurality of words has a bit width equal to the streaming interface bit width.

3. The method of claim 2, wherein the number of the plurality of words is equal to the first factor bit width divided by the streaming interface bit width.

4. The method of claim 1, wherein the second factor is received by and stored in a memory of the multiplier module, and/or the modulus is received by and stored in a memory of the modular reducer module.

5. The method of claim 2, wherein a maximum left shifter bit width and an accumulator module bit width are equal to a sum of the first factor bit width and the second factor bit width.

6. The method of claim 1, wherein the plurality of words are received from most significant bit to least significant bit.

7. The method of claim 1, wherein the output of the accumulator module is the output of the left shifter module for the first of the plurality of words.

8. The method of claim 1, wherein the partial modular reduction is performed using left-shifted versions of the modulus.

9. An electronic device, comprising:
a counter module that is configured to receive, from a streaming interface, a plurality of words for a first factor in a modular multiplication problem and to count a number of the plurality of words received from the streaming interface;
a multiplier module that is configured to multiply each of the plurality of words as it is received; a second factor in the modular multiplication problem;
a left shifter module that is configured to shifting left an output of the multiplier module;
an accumulator module that is configured to accumulate an output of the left shifter module with a partially reduced output for a prior word from a modular reducer module; and
a modular reduction module that is configured to receive a modulus, to perform partial modular reduction on an output of the accumulator module, to provide an output of the modular reducer module to the accumulator module, to perform final modular reduction on an output of the modular reducer module for a last word of the plurality of words received, resulting in a final result, and to output the final result.

10. The electronic device of claim 9, wherein the first factor has a first factor bit width, the second factor has a second factor bit width, the streaming interface has a streaming interface bit width, and each of the plurality of words has a bit width equal to the streaming interface bit width.

11. The electronic device of claim 10, wherein the number of the plurality of words is the first factor bit width divided by the streaming interface bit width.

12. The electronic device of claim 9, wherein the second factor is received by and stored in a memory of the multiplier module, and/or the modulus is received by and stored in a memory of the modular reducer module.

13. The electronic device of claim 10, wherein a maximum left shifter bit width and an accumulator module bit width are equal to a sum of the first factor bit width and the second factor bit width.

14. The electronic device of claim 9, wherein the plurality of words are received from most significant bit to least significant bit.

15. The electronic device of claim 9, wherein the output of the accumulator module is the output of the left shifter module for the first of the plurality of words.

16. The electronic device of claim 9, wherein the partial modular reduction is performed using left-shifted versions of the modulus.

17. A non-transitory computer readable storage medium, including instructions stored thereon, which when read and executed by one or more computer processors, cause the one or more computer processors to perform steps comprising:
receiving, from a streaming interface, a plurality of words for a first factor in a modular multiplication problem, wherein the plurality of words are received from most significant bit to least significant bit;
as each word is received:
counting a number of the plurality of words received from the streaming interface;
multiplying the word by a second factor in the modular multiplication problem;
shifting left a result of the multiplication;
accumulating a result of the shifting left with a partially reduced output for a prior word;
receiving a modulus and performing partial modular reduction on a result of the accumulation; and
repeating the multiplying, shifting left, accumulating, performing modular reduction, and providing for all words received from the streaming interface; and
performing final modular reduction on a result of the partial modular reduction of a last word of the plurality of words received, resulting in a final result; and
outputting the final result.

18. The non-transitory computer readable storage medium of claim 17, wherein the first factor has a first factor bit width, the second factor has a second factor bit width, the streaming interface has a streaming interface bit width, and each of the plurality of words has a bit width equal to the streaming interface bit width, and the number of the plurality of words is the first factor bit width divided by the streaming interface bit width.

19. The non-transitory computer readable storage medium of claim 18, wherein a maximum left shifter bit width and an accumulator module bit width are equal to a sum of the first factor bit width and the second factor bit width.

20. The non-transitory computer readable storage medium of claim 17, wherein the partial modular reduction is performed using left-shifted versions of the modulus.
